(19) United States
(12) Patent Application Publication
(10) Pub. No.: US 2007/0160255 A1
(43) Pub. Date: Jul. 12, 2007

(54) Earphone apparatus capable of reducing power consumption

(75) Inventors: Chia-Min Cheng, Taipei (TW); Yin-Lung Huang, Taipei (TW); Su-Yi Chang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/328,242

(22) Filed: Jan. 10, 2006

(51) Int. Cl. H04R 25/00

(52) U.S. Cl. 381/384; 381/370

(57) ABSTRACT

The present invention discloses an earphone apparatus capable of saving power consumption that comprises a transmission line, a connecting portion disposed at an end of the transmission line and coupled to a multimedia electronic device for receiving an audio source signal transmitted from the multimedia electronic device, at least one audio output portion disposed at another end of the transmission line and the each audio output portion is worn at a human ear for outputting the audio source signal from the connecting portion through the transmission line, and a sensing portion disposed at an end of the each audio output portion for detecting whether or not the audio output portion is in contact with the human ear and transmitting a play signal to the multimedia electronic device through the connecting portion, such that the multimedia electronic device outputs the audio source signal from the audio output portion.

### FIELD OF THE INVENTION

The present invention relates to an earphone apparatus, and more particularly to an earphone apparatus capable of reducing power consumption by automatically stopping or pausing a playback of an electronic multimedia device, if users have to temporarily attend to other matters.

### BACKGROUND OF THE INVENTION

As our life enters into the information era with a blooming development in the electronic industry, various different high-tech electronic products are derived rapidly from the digital technology and electronic components and peripherals installed on the electronic devices are developed constantly and used extensively in various different areas of our life and working environment. These electronic products certainly have breakthroughs to the technological developments, and such trend of development not only expedites the information distribution and its efficiency, but also brings tremendous convenience to our life and work. However, the research and development of present electronic technologies advances constantly, and thus it becomes a concern to consumers whether or not the practicability and convenience of related electronic products can meet user requirements.

With over 30 years of development in earphones, earphones have become one of the necessary equipments for hearing sounds and voices. An earphone is small and exquisite and provides a real hearing effect without distributing others. Unlike a general mono earphone and its stereo equipment, the present earphone can provide stereo surround sounds that simulate a situation of being personally on the scene.

The types of these earphones are described as follows:

(1) An earphone can be divided into two types: electric earphone and capacitive earphone according to its manufacturing principle.

a. Electric earphone is also called dynamic earphone, which features a high sensitivity, a large power resistance, a simple structure, and stable tone quality and tone color.

b. Capacitive earphone is also called electrostatic earphone, which features a wide frequency width and a good sound quality, but has a complicated structure, and a high level of difficulty for manufacturing, which is considered as a rare type.

(2) An earphone can be divided into three types: closed earphone, open earphone, and semi-open earphone according to its shape.

a. Closed earphone: It comes with an ear cushion to completely cover a human ear and provides a larger area of the earphone. This type of earphones is applicable for environments with louder sounds or noises.

b. Open earphone: It comes with a sound-transmitting ear cushion made of a soft foam plastic material and has a small volume, an easy-to-wear feature, and a non-isolating feel, but also has a drawback of a larger low-frequency loss.

c. Semi-open earphone: It is a novel earphone that combines the advantages of the closed and open earphones and adopts a multi-membrane structure. In addition to an active membrane with a vibrating source, there is still a plurality of passive membranes without a vibrating source. The semi-open earphone has a rich and soft low frequency, a bright and natural high frequency, and a clear layer feature, and thus it is a high-end earphone.

(3) Dual crossover frequency earphone: It integrates the advantages of the four types of earphones: electric, capacitive, closed, and open earphones and features a large dynamic range, a good instant response, a pure transparent sound release, and a rich sound color.

Users generally use earphones to listen to the MP3 player in daily life, but while users are listening to their MP3 player, they are frequently interrupted by other matters, such as receiving a phone call or talking with others, and thus users have to separate the earphone from their ears and always forget to turn off or pause the MP3 player. As a result, the MP3 will continue operating and playing the music, and it usually takes some time before the users discover the situation, and thus greatly wasting the power consumption.

Therefore, finding a way to provide an earphone apparatus capable of saving power consumption, such that the earphone can automatically stop playing music to reduce the waste of power and also the operating loss of a circuit in a MP3 player when a user removes the earphone from his/her ear becomes an important subject that demands immediate attention and solution.

### SUMMARY OF THE INVENTION

In view of the shortcomings of the prior, the inventor of the present invention based on years of experience in the related industry to conduct extensive researches and experiments to timely and automatically stop transmitting music to save the power consumption and the wearing out of the earphone, and finally invented an earphone apparatus capable of reducing power consumption in accordance with the present invention.

Therefore, it is an objective of the present invention to provide an earphone apparatus capable of saving power consumption that installs a connecting portion disposed at an end of an earphone apparatus and coupled to a multimedia electronic device, and the other end of the earphone apparatus includes at least one audio output portion, and each audio output portion is worn at an end of a human ear, and each audio output portion requests the multimedia electronic device to continue playing music if the human ear is detected. If each audio output portion is not in contact with a human ear and the human ear cannot be detected, the earphone apparatus will notice the multimedia electronic device to pause playing music. Therefore, the multimedia electronic device can reduce the waste of power when each audio output portion is separated from the human ear.

The above and other objects, features and advantages of the present invention will become apparent from the following detailed description taken with the accompanying drawings.

### BRIEF DESCRIPTION OF THE DRAWINGS

FIG. 1 is a schematic block diagram of the present invention;

FIG. 2 is a schematic view of a preferred embodiment of the present invention; and

FIG. 3 is a block diagram of a multimedia electronic device according to a preferred embodiment of the present invention.

### DETAILED DESCRIPTION OF THE PREFERRED EMBODIMENTS

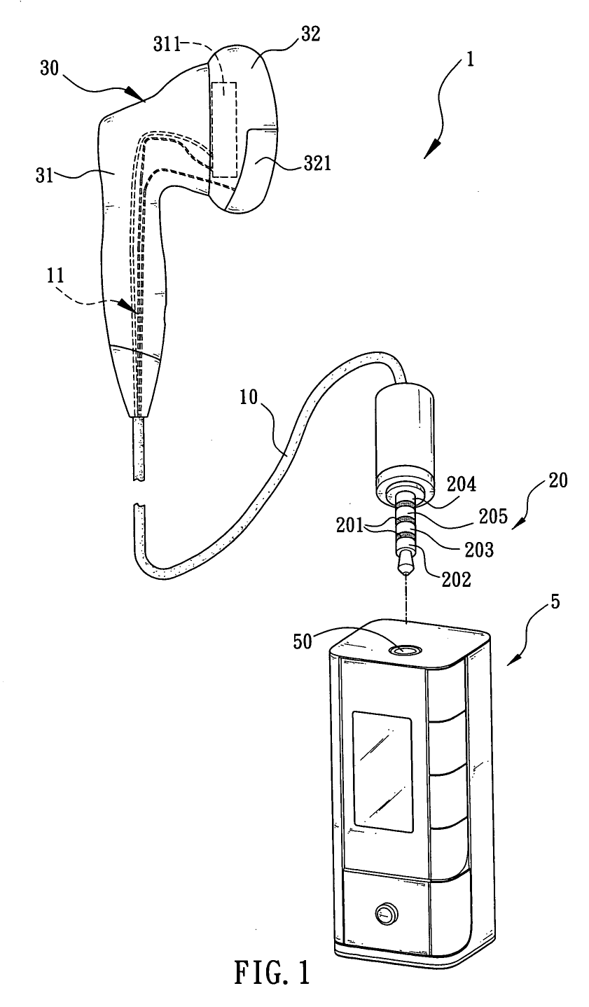

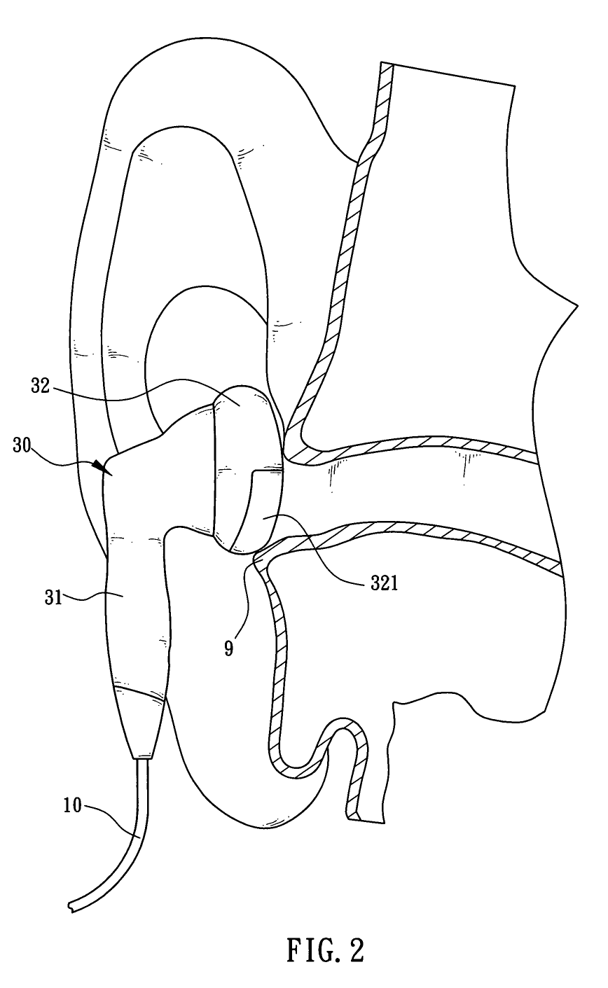

Referring to FIGS. 1 and 2 for the earphone apparatus capable of saving power consumption of the invention, an earphone apparatus 1 installs a transmission line 10, and an end of the transmission line 10 has a connecting portion 20, and the connecting portion 20 is coupled to a multimedia electronic device 5 for transmitting an audio source signal, and the other end of the transmission line 10 includes two audio output portions 30, and the audio source signal is outputted from the connecting portion 20 to each audio output portion 30 through the transmission line 10. Each audio output portion 30 includes a main body 31 and a cover 32, and the over 32 is installed at a distal end of the main body 31 away from the transmission line, and the cover 32 is disposed at an end of the main body 31 adjacent to a human ear 9. The cover 32 has a sensing portion 321 disposed around the cover 32, such that the main body 31 can be attached onto the human ear 9, and the cover 32 and the human ear 9 are in contact with each other. If the sensing portion 321 cannot detect the contact with the human ear 9, the sensing portion 321 will issue a pause signal to notice the connecting portion 20 and further pause outputting an audio source signal to a multimedia electronic device 5. On the other hand, if the sensing portion 321 detects a contact with the human ear 9, then the sensing portion 321 will issue a play signal to notice the connecting portion 20 and further drive the multimedia electronic device 5 to start transmitting the audio source signal. Therefore, as soon as the audio output portion 30 is separated from the human ear 9, the earphone apparatus 1 will make the multimedia electronic device 5 to pause transmitting the audio source signal, so as to reduce the waste of power consumption.

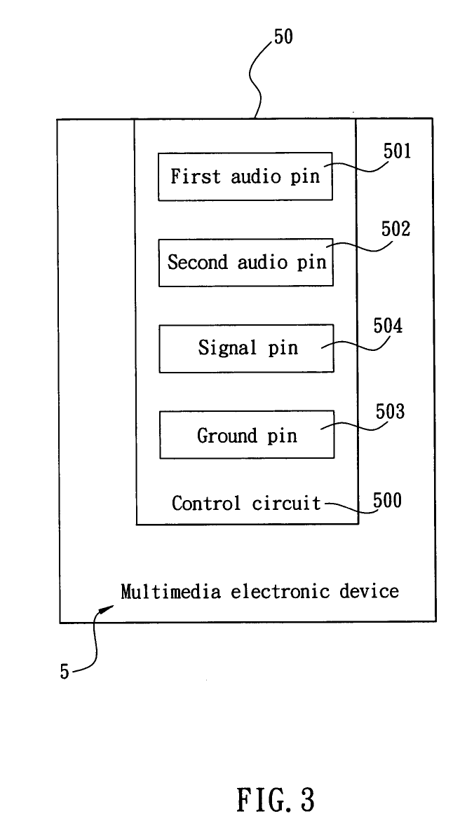

Referring to FIGS. 1, 2, and 3 for the present invention, the transmission line 10 includes a plurality of conducting wires 11 disposed between the two audio output portions and the connecting portion 20, and the conducting wires 11 connect the two audio output portions 30 and the connecting portion 20 for transmitting signals between the multimedia electronic device 5 and the two audio output portions 30, wherein the connecting portion 20 is in a cylindrical shape and at its surface sequentially has a first audio ring 202 (for a right ear signal), a second audio ring 203 (for a left ear signal), a ground (GND) 204, and a signal ring 205 (for a command signal). Each cover 32 at a position proximate to the main body 31 has a speaker 311, and the speaker 311 is coupled separately to the conducting wires 11, the first audio ring 202, and the second audio ring 203. The sensing portion 321 is coupled separately to the conducting wires 11 and the signal ring 205, and an end of each conducting wire 11 in the transmission line 10 is coupled separately to the first audio ring 202, the second audio ring 203, the ground 204, and the signal ring 205, and an insulating ring 201 is used to separate them from each other for independently transmitting signals to the outside, such that the connecting portion 20 can be coupled to an earphone transmitting end 50 of the multimedia electronic device 5 for transmitting the audio source signal.

In FIGS. 1, 2, and 3, the multimedia electronic device 5 in the earphone transmitting end 50 includes a control circuit 500, and the control circuit 500 includes a first audio pin 501 (for the right ear pin), a second audio pin 502 (for the left ear pin), a ground pin (GND pin) 503, and a signal pin 504 (which is a command pin) at the positions corresponding to the first audio ring 202, the second audio ring 203, the ground 204, and the signal ring 205 on the connecting portion 20 respectively. The first audio pin 501 and the second audio pin 502 can transmit the audio source signal played by the multimedia electronic device 5, and the signal pin 504 can receive the play signal or the pause signal transmitted from the sensing portion 321 to the multimedia electronic device 5.

If the multimedia electronic device 5 is turned on and the cover 32 is in contact with the. human ear 9, then the first and second audio pins 501, 502 will send the audio source signal to the two speakers 311 through the first and second video rings 202, 203 of the connecting portion 20 to continue playing videos. If a user has to stop listening to the multimedia electronic device 5 due to other matters (such as receiving a telephone call or talking to others) and separate the cover 32 from the ear 9, then the two sensing portions 321 will send out the pause signal through the signal ring 205 and the signal pin 504 and notice the multimedia electronic device 5 to stop outputting the audio source signal, when the two sending portions 321 detect that the cover 32 is separated from the ear 9.

The sensing portion 321 is disposed at a side of the cover 32 that is in contact with the human ear 9, and the sensing portion 321 could be a touch sensor that uses the principle of detecting the human ear 9 being in contact with the sensing portion 321 to control a metal plate. If the touch sensor cannot detect the pressure produced by pressing the human ear 9, a detect signal will be sent to the multimedia electronic device 5. If the touch sensor is separated from the human ear 9, then the sensing portion 321 will be able to control the multimedia electronic device 5 by this method. The sensing portion 321 could be an optical sensor. If the cover 32 is worn in the human ear 9, the optical sensor will not be able to detect the light to send the detect signal to the multimedia electronic device 5. Alternatively, the sensing portion 321 could be an infrared sensor, such that if the cover 32 is separated from the human ear 9, then the infrared sensor will be unable to detect the reflected infrared ray to send out the detect signal to the multimedia electronic device 5. With the foregoing design, if the audio output portion 30 is separated from the human ear 9, a video signal transmitted from the multimedia electronic device 5 is no longer efficient. Therefore, the separation of the audio output portion 30 from an ear is used for controlling the playback operation of the multimedia electronic device 5 and saving power. Therefore, the present invention can greatly improve over the prior art.

While the invention herein disclosed has been described by means of specific embodiments, numerous modifications and variations could be made thereto by those skilled in the art without departing from the scope and spirit of the invention set forth in the claims.

What is claimed is:

1. An earphone apparatus capable of saving power consumption, comprising:
a transmission line;
a connecting portion, disposed at an end of said transmission line and coupled to a multimedia electronic device for receiving an audio source signal transmitted from said multimedia electronic device;
at least one audio output portion, disposed at another end of said transmission line, and said each audio output portion is worn at a human ear for outputting said audio source signal from said connecting portion through said transmission line; and
a sensing portion, disposed at an end of said each audio output portion for detecting whether or not said audio output portion is in contact with said human ear and transmitting a play signal to said multimedia electronic device through said connecting portion, such that said multimedia electronic device outputs said audio source signal from said audio output portion.

2. The earphone apparatus of claim 1, wherein said each audio output portion comprises:
a main body; and
a cover, covered onto said main body at a position away from an end of said transmission line, and being in contact with said human ear, and said sensing portion being disposed around said cover at a position in contact with said human ear.

3. The earphone apparatus of claim 2, wherein said each sensing portion will send out a pause signal to said multimedia electronic device, if said each sensing portion does not detect any audio output portion, so that said multimedia electronic device pauses outputting said audio source signal according to said pause signal.

4. The earphone apparatus of claim 3, wherein said transmission line includes a plurality of conducting wires disposed between said each audio output portion and said connecting portion, and said each audio output portion is coupled to said connecting portion by said each conducting wire for transmitting signals between said multimedia electronic device and said two audio output portions.

5. The earphone apparatus of claim 3, wherein said connecting portion is substantially in a cylindrical shape and at its surface sequentially comprises:
a ground;
a first audio ring, for transmitting said audio source signal from said multimedia electronic device to said each audio output portion;
a second audio ring, for transmitting said audio source signal from said multimedia electronic device to said each audio output portion; and
a signal ring, for transmitting said play signal from said sensing portion to said multimedia electronic device.

6. The earphone apparatus of claim 5, wherein said each cover includes a speaker proximate to said main body, and two speakers are coupled separately to said first audio ring and said second audio ring by said conducting wires.

7. The earphone apparatus of claim 5, wherein said ground, said first audio ring, said second audio ring, and said signal ring are separated with each other by an insulating ring for independently transmitting signals to the outside.

8. The earphone apparatus of claim 5, wherein said sensing portion is coupled to said signal ring by said conducting wires.

9. The earphone apparatus of claim 5, wherein said sensing portion is a touching type sensor.

10. The earphone apparatus of claim 5, wherein said sensing portion is an optical sensor.

11. The earphone apparatus of claim 5, wherein said sensing portion is an infrared sensor.
